(19) United States
(12) Patent Application Publication
(10) Pub. No.: US 2024/0409153 A1
(43) Pub. Date: Dec. 12, 2024

(54) REAR WHEEL STEERING SYSTEM

(71) Applicants: INVENTEC (PUDONG) TECHNOLOGY CORPORATION, Shanghai (CN); INVENTEC CORPORATION, Taipei City (TW)

(72) Inventor: Chi-Min LIEN, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/592,202

(22) Filed: Feb. 29, 2024

(30) Foreign Application Priority Data
Jun. 6, 2023 (CN) 202310666708.X

(51) Int. Cl. B62D 5/04; B62D 6/00; B62D 6/02

(52) U.S. Cl. CPC B62D 5/046; B62D 6/001; B62D 6/002; B62D 6/02

(57) ABSTRACT

A rear wheel steering system includes a triaxial accelerometer and an electronic control circuit, wherein the triaxial accelerometer is connected to the electronic control circuit. The triaxial accelerometer is configured to detect the current acceleration of the vehicle. The electronic control circuit is configured to generate and output a steering command to control two rear wheels of the vehicle according to at least the current acceleration when the current acceleration is greater than a preset acceleration.

### CROSS-REFERENCE TO RELATED APPLICATIONS

This non-provisional application claims priority under 35 U.S.C. § 119 (a) on Patent Application No(s). 202310666708.X filed in China on Jun. 6, 2023, the entire contents of which are hereby incorporated by reference.

### BACKGROUND

### 1. Technical Field

This disclosure relates to a steering system, particularly to a rear wheel steering system.

### 2. Related Art

Among currently commercially available vehicles, most vehicles only include front wheel steering systems, and only a small number of vehicle models disposed with rear wheel steering systems. Through the rear wheel steering system, the inner wheel difference and steering radius may be reduced when the vehicle turns. The electronic steering system may assist the driver in steering the wheel through electronic devices especially providing greater power assistance when driving at low speeds allowing the driver to turn more easily. However, whether it is front or rear wheel steering or electronic steering systems, the system still relies on the driver to steer through the steering wheel.

### SUMMARY

In view of the above description, this disclosure provides a rear wheel steering system with an active steering function.

A rear wheel steering system according to an embodiment of this disclosure includes a triaxial accelerometer and an electronic control circuit, wherein the triaxial accelerometer is connected to the electronic control circuit. The triaxial accelerometer is configured to detect the current acceleration of a vehicle. The electronic control circuit is configured to generate and output a steering command to control the two rear wheels of the vehicle according to at least the current acceleration when the current acceleration is greater than the preset acceleration.

In view of the above structure, the rear wheel steering system of this disclosure may measure the acceleration of the vehicle when the vehicle is impacted and output the steering command to control the steering of the rear wheels according to the current acceleration of the vehicle, which providing an active steering function to stabilize the vehicle body.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a rear wheel steering system according to an embodiment of this disclosure;

FIG. 2 is a functional block diagram of a rear wheel steering system according to another embodiment of this disclosure;

FIG. 3 is a flowchart of a method for generating a steering command according to an embodiment of this disclosure; and

FIG. 4 is a functional block diagram of a rear wheel steering system according to yet another embodiment of this disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

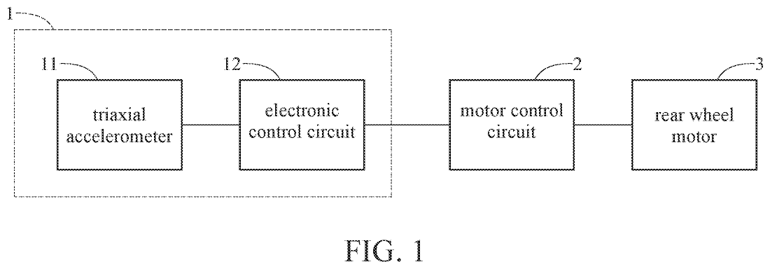

Please refer to FIG. 1, which is a functional block diagram of a rear wheel steering system according to an embodiment of this disclosure. As shown in FIG. 1, the rear wheel steering system 1 includes a triaxial accelerometer 11 and an electronic control circuit 12. The triaxial accelerometer 11 and the electronic control circuit 12 are connected to each other. The electronic control circuit 12 may be connected to the motor control circuit 2. The motor control circuit 2 may include a motor driver and a bridge circuit and be configured to control a rear wheel motor 3.

The triaxial accelerometer 11 is configured to detect the current acceleration of a vehicle. The electronic control circuit 12 is configured to generate and output a steering command to control the two rear wheels of the vehicle to the motor control circuit 2 according to at least the current acceleration when the current acceleration detected by the triaxial accelerometer 11 is greater than the preset acceleration, wherein the preset acceleration may be but is not limited to 30 g. Specifically, the electronic control circuit 12 may determine whether the rotation direction indicated by the steering command is left or right according to the direction of the current acceleration, or/and may determine the rotation angle indicated by the steering command according to the value of the current acceleration. The motor control circuit 2 may control the rear wheel motor 3 to rotate the rear wheels of the vehicle according to the steering command. Moreover, in addition to the aforementioned rotation direction or/and rotation angle, the steering command may further include a rotation duration, wherein the rotation duration may be set to 2 seconds but is not limited to this.

In an implementation, the electronic control circuit 12 may be implemented by a microcontroller having the function of electric power steering (EPS) for the rear wheels. The electronic control circuit 12 may enter the EPS mode when the electronic control circuit 12 determines that the current acceleration is greater than a preset acceleration to control the rear wheels to actively rotate left or right through the motor control circuit 2, and the microcontroller returns the control of the motor control circuit 2 to a vehicle stabilization unit such as a vehicle control unit (VCU) after maintaining the rotation for a rotation duration.

In another implementation, the electronic control circuit 12 includes a microcontroller and a rear wheel EPS control unit, wherein the microcontroller is connected to the triaxial accelerometer 11, and the rear wheel EPS control unit is connected to the microcontroller and the motor control circuit 2. The microcontroller is configured to notify the rear wheel EPS control unit to intervene to control the rear wheel to actively rotate left or right through the motor control circuit 2 when determining that the current acceleration detected by the triaxial accelerometer 11 is greater than the preset acceleration, and the microcontroller returns the control of the motor control circuit 2 to a vehicle stabilization unit such as a VCU after maintaining the rotation for a rotation duration.

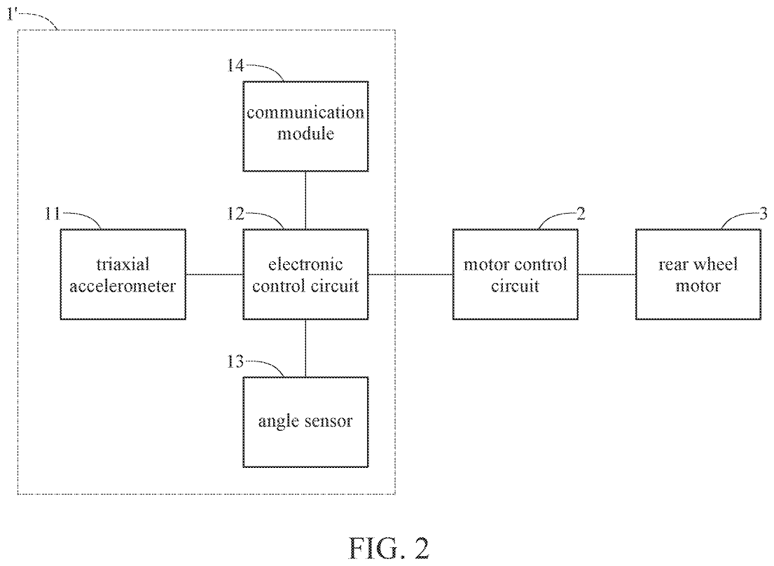

Please refer to FIG. 2, which is a functional block diagram of a rear wheel steering system according to another embodiment of this disclosure. As shown in FIG. 2, the rear wheel steering system 1′ includes a triaxial accelerometer 11, an electronic control circuit 12, an angle sensor 13 and a communication module 14. The functions and connection relationships of the triaxial accelerometer 11 and the electronic control circuit 12 are the same as those shown in FIG. 1, and therefore will not be described again. The angle sensor 13 and the communication module 14 are connected to the electronic control circuit 12. Specifically, the connection between the electronic control circuit 12 and each of the triaxial accelerometer 11, the angle sensor 13 and the communication module 14 and may be a wired connection or a wireless connection. The angle sensor 13 and the communication module 14 are optional disposed devices.

The angle sensor 13, such as a rotary position sensor, is configured to sense the angle of the rear wheel motor 3 of the two rear wheels. In addition to the current acceleration, the electronic control circuit 12 may generate the steering command according to the motor angle. That is to say, the electronic control circuit 12 may generate and output the steering command according to the motor angle and current acceleration detected by the angle sensor 13. The communication module 14, such as an Internet module or a Bluetooth communication module, is configured to be connected to the bus of the vehicle. Specifically, the communication module 14 may be a controller area network transceiver and is configured to be connected to the bus of the controller area network.

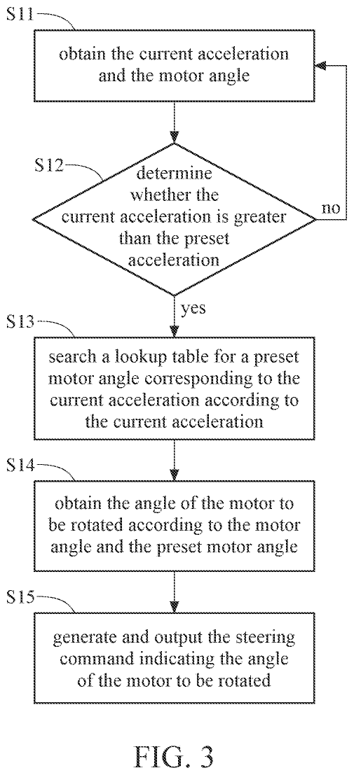

Please refer to FIG. 3, which is a flow chart of a method for generating a steering command according to an embodiment of this disclosure. As shown in FIG. 3, the method for generating a steering command includes step S11: obtaining the current acceleration and the motor angle; step S12: determining whether the current acceleration is greater than the preset acceleration; if the current acceleration is not greater than the preset acceleration, performing step S11 again; if the current acceleration is greater than the preset acceleration, performing step S13: searching the lookup table for the preset motor angle corresponding to the current acceleration according to the current acceleration; step S14: obtaining the angle of the motor to be rotated according to the motor angle and the preset motor angle; and step S15: generating and outputting the steering command indicating the angle of the motor to be rotated. The method for generating a steering command may be applied to the rear wheel steering system shown in FIG. 2, and the method shown in FIG. 3 is illustrated below with the rear wheel steering system shown in FIG. 2 as an example.

In step S11, the electronic control circuit 12 obtains the current acceleration and motor angle. Specifically, when the vehicle is subject to a side collision while driving, the triaxial accelerometer 11 may obtain the current acceleration of the vehicle and the angle sensor 13 may obtain the angle of the rear wheel motor 3, and they may transmit the current acceleration and the motor angle to the electronic control circuit 12.

In step S12, the electronic control circuit 12 determines whether the current acceleration is greater than the preset acceleration. If the current acceleration is greater than the preset acceleration, the electronic control circuit 12 performs step S13; otherwise, the electronic control circuit 12 returns to step S11 again and waits for the current acceleration and the motor angle measured and transmitted by the triaxial accelerometer 11 or controls the triaxial accelerometer 11 and the angle sensor 13 to perform measurements and return the current acceleration and the motor angle.

In step S13, the electronic control circuit 12 searches the lookup table for the preset motor angle corresponding to the current acceleration according to the current acceleration. Specifically, the lookup table is stored in the electronic control circuit 12. The lookup table may include a number of motor angles corresponding to a number of preset accelerations, in other words, the angle at which the rear wheels should be turned under each preset acceleration. For example, the lookup table may be in the form of Table 1, where a preset wheel angle corresponds to a preset motor angle. Specifically, the preset wheel angle may directly serve as the preset motor angle, or be converted into the preset motor angle through a preset relational expression.

TABLE 1

| Preset acceleration | Preset wheel angle |
|---|---|
| 20 g-40 g | 1° |
| 40 g-60 g | 2° |
| >60 g | 3° |

In step S14, the electronic control circuit 12 obtains the angle of the motor to be rotated according to the motor angle measured by the angle sensor 13 and the preset motor angle. Specifically, after the electronic control circuit 12 obtains the preset motor angle, it may compare the preset motor angle with the measured motor angle to confirm how much the rear wheel motor needs to be further rotated to meet the preset motor angle, that is, to confirm the angle of the motor to be rotated. More specifically, the electronic control circuit 12 may use the difference between the preset motor angle and the measured motor angle as the angle of the motor to be rotated.

In step S15, the electronic control circuit 12 generates and outputs the steering command indicating the angle of the motor to be rotated. Specifically, the electronic control circuit 12 generates the steering command indicating the angle of the motor to be rotated according to the angle of the motor to be rotated calculated in step S14 and sends the steering command to the motor control circuit 2. Then, the motor control circuit 2 may control the rear wheel motor 3 to rotate the angle of the motor to be rotated to reach the preset motor angle according to the steering command. However, the steering command may not only indicate the angle of the motor to be rotated of the rear wheel motor, but also indicate the steering duration of the rear wheel motor. The following explains how to control the rear wheel steering duration.

In another embodiment, in addition to the correspondence between the preset acceleration and the preset motor angle, the lookup table may further include the correspondence between the preset acceleration and the preset steering duration. The electronic control circuit 12 may obtain the preset steering duration corresponding to the current acceleration from the lookup table and use the preset steering duration as part of the information of the steering command. That is to say, the steering command not only indicates the angle of the motor to be rotated, but also indicates the preset steering duration.

In yet another embodiment, step S15 may include obtaining the target steering duration according to the angle of the motor to be rotated and the preset motor speed, and the steering command may include the target steering duration.

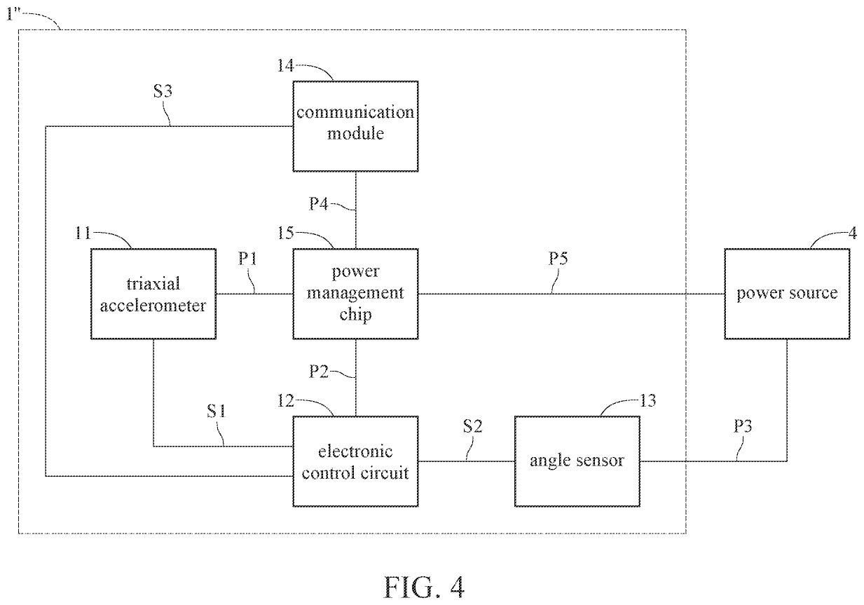

Please refer to FIG. 4, which is a functional block diagram of a rear wheel steering system according to yet another embodiment of this disclosure. As shown in FIG. 4, the rear wheel steering system 1″ includes a triaxial accelerometer 11, an electronic control circuit 12, an angle sensor 13, a communication module 14 and a power management chip 15. In FIG. 4, the line segments S1 to S3 represent signal connection relationships and the line segments P1 to P5 represent power connection relationships. The implementation devices, functions and signal connection relationships of the triaxial accelerometer 11, electronic control circuit 12, angle sensor 13, and communication module 14 (that is, the line segments S1 to S3) are the same as those shown in FIG. 2 and will not be described again here.

The power management chip 15 is electrically connected to the triaxial accelerometer 11, the electronic control circuit 12 and a power source 4 and is configured to receive the power from the power source 4 (the line segment P5) and distribute the power to the triaxial accelerometer 11 (the line segment P1) and the electronic control circuit 12 (the line segment P2). In addition, the power source 4 may distribute power to the angle sensor 13 (the line segment P3) and the power management chip 15 may further distribute the power to the communication module 14 (the line segment P4).

In one or more embodiments of this disclosure, the wheel steering system of this disclosure may be applied to a vehicular device, such as an autonomous vehicle, an electric vehicle, a semi-autonomous vehicle, etc.

In view of the above structure, the rear wheel steering system of this disclosure may measure the acceleration of the vehicle when the vehicle is impacted and output the steering command to control the steering of the rear wheels according to the current acceleration of the vehicle, which providing an active steering function to stabilize the vehicle body.

What is claimed is:

1. A rear wheel steering system, comprising:
a triaxial accelerometer configured to detect a current acceleration of a vehicle; and
an electronic control circuit connected to the triaxial accelerometer, and configured to generate and output a steering command to control two rear wheels of the vehicle according to at least the current acceleration when the current acceleration is greater than a preset acceleration.

2. The rear wheel steering system according to claim 1, further comprising:
an angle sensor configured to sense a motor angle of the two rear wheels;
wherein the electronic control circuit is further connected to the angle sensor, and configured to generate and output the steering command according to the motor angle and the current acceleration.

3. The rear wheel steering system according to claim 2, wherein an execution of the electronic control circuit for generating and outputting the steering command according to the motor angle and the current acceleration comprises:
searching a lookup table for a preset motor angle corresponding to the current acceleration according to the current acceleration;
obtaining an angle to be rotated according to the motor angle of the two rear wheels and the preset motor angle; and
generating and outputting the steering command indicating the angle to be rotated.

4. The rear wheel steering system according to claim 3, wherein the lookup table further comprises a preset steering duration corresponding to the current acceleration, and the steering command further indicates the preset steering duration.

5. The rear wheel steering system according to claim 3, wherein an execution of the electronic control circuit of generating and outputting the steering command indicating the angle to be rotated comprises obtaining a target steering duration according to the angle to be rotated and a preset motor rotation speed, and the steering command comprises the target steering duration.

6. The rear wheel steering system according to claim 1, wherein the electronic control circuit is configured to determine a rotation direction indicated by the steering command according to a direction of the current acceleration.

7. The rear wheel steering system according to claim 1, wherein the preset acceleration is 30 g.

8. The rear wheel steering system according to claim 1, further comprising:
a power management chip electrically connected to the triaxial accelerometer and the electronic control circuit, and configured to receive power from a power source and distribute the power to the triaxial accelerometer and the electronic control circuit.

9. The rear wheel steering system according to claim 1, further including:
a communication module connected to the electronic control circuit, and configured to be connected to a bus of the vehicle.

10. The rear wheel steering system according to claim 9, wherein the communication module is a controller area network transceiver.
